(19) United States
(12) Patent Application Publication
(10) Pub. No.: US 2024/0157867 A1
(43) Pub. Date: May 16, 2024

(54) LAMP AND METHOD FOR OPERATING THE SAME

(71) Applicant: HYUNDAI MOBIS CO., LTD., Seoul (KR)

(72) Inventor: Myeong Je KIM, Yongin-si (KR)

(73) Assignee: HYUNDAI MOBIS CO., LTD., Seoul (KR)

(21) Appl. No.: 18/146,195

(22) Filed: Dec. 23, 2022

(30) Foreign Application Priority Data
Nov. 15, 2022 (KR) 10-2022-0152644

(51) Int. Cl. B60Q 1/076; B60Q 1/08; B60Q 1/14; F21S 41/663; F21V 23/00

(52) U.S. Cl. CPC B60Q 1/076; B60Q 1/08; B60Q 1/1415; F21S 41/663; F21V 23/003

(57) ABSTRACT

A lamp including a first output part including a plurality of light sources that irradiate light to a first area, a second output part that outputs an image in a second area, and a controller that controls the first output part and the second output part, and the controller may control at least one of lighting and a brightness of, among the plurality of light sources included in the first output part, a light source corresponding to an overlapping area, in which the first area and the second area overlap each other.

### CROSS-REFERENCE TO RELATED APPLICATION

This application claims the benefit of priority to Korean Patent Application No. 10-2022-0152644, filed in the Korean Intellectual Property Office on Nov. 15, 2022, the entire contents of which are incorporated herein by reference.

### TECHNICAL FIELD

The present disclosure relates to a lamp and a method for operating the same.

### BACKGROUND

In general, headlamps for a vehicle are used to secure a stable front field of view in a situation, such as nighttime, a tunnel having a dark surrounding environment, fog, rain, and the like.

In recent years, the headlamp for a vehicle has employed a high-resolution LED as the high-resolution LEDs have been increasingly used. Accordingly, a technology and an application for projecting an image to a road surface or a specific object by using the headlamp of the vehicle have been developed.

### SUMMARY

The present disclosure has been made to solve the above-mentioned problems occurring in the prior art while advantages achieved by the prior art are maintained intact.

However, generally, because the high-resolution LED has a narrow view angle to increases resolution so as to project an image, a low-beam area for securing a field of view of a driver and an area, in which information (an image and the like) is displayed on a road surface through the high-resolution LED, overlap each other whereby a visibility of information displayed on the road surface deteriorates.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a lamp includes a first output part including a plurality of light sources that irradiate light to a first area, a second output part that outputs an image in a second area, and a controller that controls the first output part and the second output part, and the controller may be configured to control at least one of lighting and a brightness of, among the plurality of light sources included in the first output part, a light source corresponding to an overlapping area, in which the first area and the second area overlap each other.

According to an embodiment, the controller may be configured to switch off, among the plurality of light sources included in the first output part, the light source corresponding to the overlapping area.

According to an embodiment, the controller may be configured to decrease a brightness of, among the plurality of light sources included in the first output part, the light source corresponding to the overlapping area as the light source corresponds to a point that is closer to a center of the overlapping area.

According to an embodiment, the controller may be configured to control lighting of the first output part and the second output part by setting duty rates of the first output part and the second output part.

According to an embodiment, the controller may be configured to set the duty rates of the first output part and the second output part such that on times of the first output part and the second output part do not overlap each other.

According to an embodiment, the controller may be configured to set a transient section between the on times of the first output part and the second output part.

According to an embodiment, the controller may be configured to set the duty rate of the second output part to 100% and set the duty rate of the first output part to less than 50%.

According to an embodiment, the controller may be configured to perform a control such that the second output part outputs the image when the first output part is in an off state, and switch on all the light sources included in the second output part when the first output part is in an on state.

According to an embodiment, the second output part may include a first output module and a second output module, and the controller may be configured to control the second output part such that the image is output in a third area included in the second area, in which an irradiation area of the first output module and an irradiation area of the second output module overlap each other.

According to an embodiment, the first area may be a low-beam area and the second area is a high-resolution area.

According to an embodiment, the lamp may further include a storage part that stores information related to the image.

According to an aspect of the present disclosure, a method for operating a lamp includes controlling a first output part including a plurality of light sources that irradiate light to a first area and a second output part that outputs an image in a second area, controlling at least one of lighting and a brightness of, among the plurality of light sources included in the first output part, a light source corresponding to an overlapping area, in which the first area and the second area overlap each other, irradiating the light to the first area through the first output part, and outputting the image in the second area through the second output part.

According to an embodiment, the controlling of at least one of the lighting and the brightness of, among the plurality of light sources included in the first output part, the light source corresponding to the overlapping area, in which the first area and the second area overlap each other may include switching off, among the plurality of light sources included in the first output part, the light source corresponding to the overlapping area.

According to an embodiment, the controlling of at least one of the lighting and the brightness of, among the plurality of light sources included in the first output part, the light source corresponding to the overlapping area, in which the first area and the second area overlap each other may include decreasing the brightness of, among the plurality of light sources included in the first output part, the light source corresponding to the overlapping area as the light source corresponds to a point that is closer to a center of the overlapping area.

According to an embodiment, the controlling of the first output part and the second output part may include controlling the lighting of the first output part and the second output part by setting duty rates of the first output part and the second output part.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram of a lamp according to an embodiment disclosed in the present disclosure;

FIGS. 2A and 2B are views illustrating an example of controlling a light source of a first output part by a controller according to an embodiment disclosed in the present disclosure;

FIGS. 3A to 3C are views illustrating an example of setting duty rates of a first output part and a second output part by a controller according to an embodiment disclosed in the present disclosure;

FIG. 4 is a view illustrating an example of outputting an image in a third area by a controller according to an embodiment of the present disclosure; and

FIG. 5 is a flowchart illustrating a method for operating a lamp according to an embodiment disclosed in the present disclosure.

### DETAILED DESCRIPTION

Hereinafter, various embodiments of the present disclosure will be described with reference to the accompanying drawings. Accordingly, those of ordinary skill in the art will recognize that modifications, equivalents, and/or alternatives on the various embodiments described herein can be variously made without departing from the scope and spirit of the present disclosure.

In the present disclosure, it is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “1st” and “2nd” or “first” and “second” may be used to simply distinguish a corresponding component from another, and does not limit the components in other aspects (e.g., an importance or an order). Such terms as “1st” and “2nd” or “first” and “second” may be used to simply distinguish a corresponding component from another, and does not limit the components in other aspects (e.g., an importance or an order).

The components (e.g., modules or programs) described in the present disclosure may include a singular or a plurality of entities. According to various embodiments, among the components, one or more components or operations may be omitted or one or more other components or operations may be added. Alternatively or additionally, the plurality of components (e.g., modules or programs) may be integrated into one component. In this case, the integrated components may perform one or more functions of the plurality of components in a way that is the same as or similar to that performed by the corresponding ones of the plurality of components before the integration. According to various embodiments, the operations performed by modules, programs, or other components may be executed sequentially, in parallel, repeatedly, or heuristically, one or more operations may be executed in another sequence or omitted, or one or more other operations may be added.

The term “module” or “part” used in the present disclosure may include a unit configured in a hardware, software, or firmware way, and for example, may be used interchangeably with the terms such as logic, a logic block, a component, or a circuit. The module may be an integral part, or a minimum unit or a portion which performs one or more functions. For example, according to an embodiment, the module may be implemented in a form of an application-specific integrated circuit (ASIC).

Various embodiments of the present disclosure may be implemented by software (e.g., a program or an application) including one or more instructions stored in a storage medium (e.g., a memory) that may be read by a machine. For example, a processor of a device may call, among one or more instructions stored in a storage medium, at least one instruction, and may execute the instruction. This allows at least one function to be performed according to the called at least one instruction. The one or more instructions may include a code that is made by a compiler or a code that may be executed by an interpreter. The storage medium that may be read by a device may be provided in a form of a non-transitory storage medium. Here, the ‘non-transitory storage medium’ means that the storage medium is a tangible device and does not include a signal (e.g., an electromagnetic wave), and with regard to the term, a case, in which data are semi-permanently stored in the storage medium, and a case, in which data are temporarily stored in the storage medium, are not distinguished.

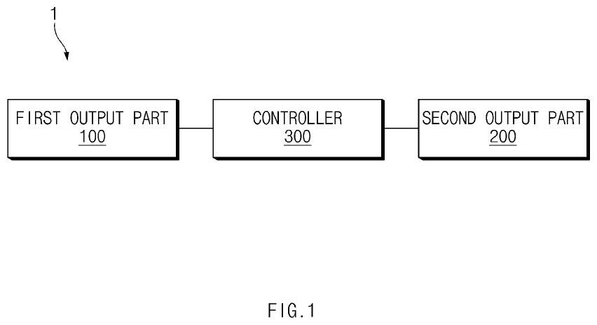

FIG. 1 is a block diagram of a lamp according to an embodiment disclosed in the present disclosure.

Referring to FIG. 1, a lamp 1 may include a first output part 100, a second output part 200, and a controller 300.

The lamp 1 may include various lamps that are present in a vehicle, for example, headlamps, rear lamps, tail lamps, and the like. As an example, the lamp 1 may be the headlamp of the vehicle, and the headlamp may include a high-resolution headlamp using a digital micro-mirror device, an LED MATRIX, and the like. The lamp 1 may display various pieces of information by irradiating light to a road surface and the like and thus outputting an image. The lamp 1 may be integrally formed with internal control units of the vehicle, and may be implemented by a separate device to be connected to the control units of the vehicle to be operated. The lamp 1 may include the first output part 100 that irradiates light for securing a field of view of a driver, and the second output part 200 that outputs an image including information on a road surface or the like, and the lamp 1 may enhance a visibility of the image displayed on the road surface or the like and/or a low-beam area by controlling lighting, brightness, and the like of the first output part 100 and the second output part 200. In addition, the lamp 1 may include configurations, such as a driving part (for example, a leveling device) for controlling irradiation directions of the first output part 100 and the second output part 200, a sensor (for example, a lidar sensor) for recognizing a facing vehicle, and the like.

According to an embodiment, the first output part 100 may include a plurality of light sources for irradiating light in a first area. The first output part 100 may output a low beam, and the first area may be a low-beam area. The plurality of light sources may be LEDs, micro-LEDs, OLEDs, and QLEDs, and in addition, may be various light sources, such as halogen lamps or LCDs, which may irradiate light. The first output part 100 may allow the driver to secure a field of view by irradiating the light to a front side of the vehicle and thus allowing the drive to identify the road surface or the like.

According to an embodiment, the second output part 200 may output an image in a second area. The second output part 200 may irradiate light to an entire portion or a portion of the second area, and the light irradiated to the second area may express an image. The image may express various pieces of information, such as various traffic symbols (a left turn, a right turn, a straight movement, and the like), display of an alarm, and display of a speed limit. The second area may be an area for displaying the image, and for example, may be located on the road surface. The second output part 200 may be a high-resolution lamp for outputting the image on the road surface, and the second area may be a high-resolution area. Then, the high-resolution area may include an information display area that outputs the image on the road surface by the second output part 200, and an adaptive driving beam area that actively adjusts an output based in the weather or an illumination intensity. The second output part 200 may output the image including various pieces of information on a road surface, and may deliver the information to the driver.

According to an embodiment, the controller 300 may control the first output part 100 and the second output part 200. As an example, the first output part 100 may output a low beam and the second output part 200 may output a high-resolution beam, and the controller 300 may control the brightness and the lighting of the first output part 100 and the second output part 200 by controlling the output of the low-beam and high-resolution beam to improve the visibility of the image output to the road surface by the high-resolution beam and the visibility of the low-beam area for securing a driver's field of view.

According to an embodiment, the controller 300 may control at least one of lighting and a brightness of, among a plurality of light sources included in the first output part 100, a light source corresponding to an overlapping area, in which the first area and the second area overlap each other. Because the second area is an area, in which the image is output by the second output part 200, and when the first output part 100 continues to be on without a separate control, the visibility of the image may be degraded due to the light irradiated by the first output part 100. Accordingly, the controller 300 may control the light source corresponding to the overlapping area, in which the first area and the second area overlap each other such that the visibility of the road surface for securing the field of view of the driver may be secured while the visibility of the image is enhanced.

According to an embodiment, the controller 300 may include an electric circuit that executes a command of software, and accordingly, may perform various data processing and calculations. The controller 300, for example, may include a micro processor unit (MPU), a micro controller unit (MCU), a central processing unit (CPU), and an electronic controller unit (ECU).

According to an embodiment, the lamp 1 may further include a storage part (not illustrated) that stores the information related to the image. The storage part may include a memory, and the memory may be a volatile memory and may be a nonvolatile memory. The volatile memory may include a RAM, a DRAM, and an SRAM, and the nonvolatile memory may include a ROM, a PROM, an EAROM, an EPROM, an EEPROM, and a flash memory. The above-listed examples of the memories are simply exemplary and the present disclosure is not limited to the examples. The information related to the image may include information on, for example, an image file, a shape of an image, coordinate values for pixels, and illumination intensity values.

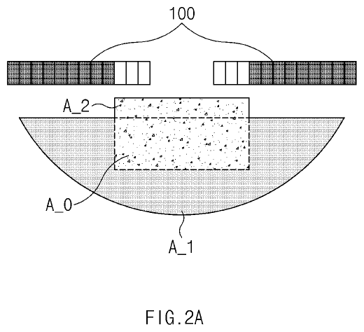

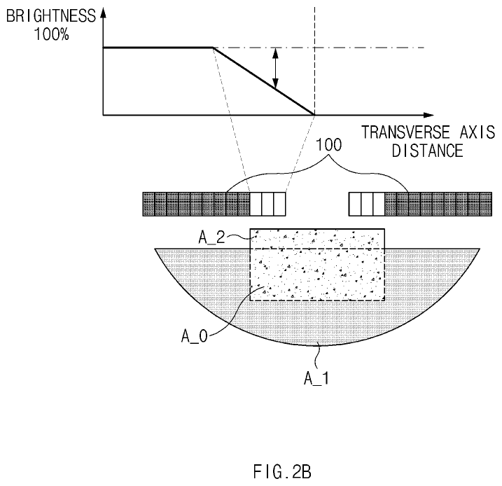

FIGS. 2A and 2B are views illustrating an example of controlling a light source of the first output part by the controller according to an embodiment disclosed in the present disclosure.

Referring to FIGS. 2A and 2B, the controller 300 may control at least one of the lighting and the brightness of, among the plurality of light sources of the first output part 100, the light source corresponding to the overlapping area. In FIGS. 2A and 2B, A_1 denotes the first area, A_2 denotes the second area, and A_O denotes the overlapping area, in which the first area and the second area overlap each other. Furthermore, the light source indicated by a white color in FIGS. 2A and 2B is the light source corresponding to the overlapping area A_O, and the light source indicated by a gray color is a light source that does not correspond to the overlapping area A_O.

First, referring to FIG. 2A, the controller 300 may switch off, among the plurality of light sources included in the first output part 100, the light source corresponding to the overlapping area A_O. Then, the controller 300 may switch on, among the plurality of light sources included in the first output part 100, the light sources that do not correspond to the overlapping area A_O.

For example, the controller 300 may enhance the visibility of the image in the overlapping area A_O by switching off, among twelve light sources included in the first output part 100, three light sources corresponding to the overlapping area A_O. Furthermore, the visibility of the low-beam area may be secured by switching on the remaining nine light sources that do not correspond to the overlapping area A_O.

The number of the light sources included in the first output part 100 illustrated in FIG. 2A and the number of the switched-off light sources are exemplary, and the present disclosure is not limited thereto.

Referring to FIG. 2B, the controller 300 may decrease a brightness of, among the plurality of light sources included in the first output part 100, the light source corresponding to the overlapping area as the light source corresponds to a point that is closer to the center of the overlapping area. Then, the controller 300 may perform a control to linearly decrease the brightnesses of the light sources corresponding to the overlapping area A_O, and in addition, may perform a control to decrease the brightnesses in various forms. Furthermore, the controller 300 may switch on, among the plurality of light sources included in the first output part 100, the light sources that do not correspond to the overlapping area A_O.

For example, in FIG. 2B, it may be identified that the controller 300 performs a control to switch off, among three light sources corresponding to the overlapping area A_O, the final light source that is closest to the center of the overlapping area A_O, and controls the remaining two light sources to decrease the brightnesses instead of the switch off. Through this, the controller 300 may enhance the visibility of the image by performing a control to display the image such that the image is brighter.

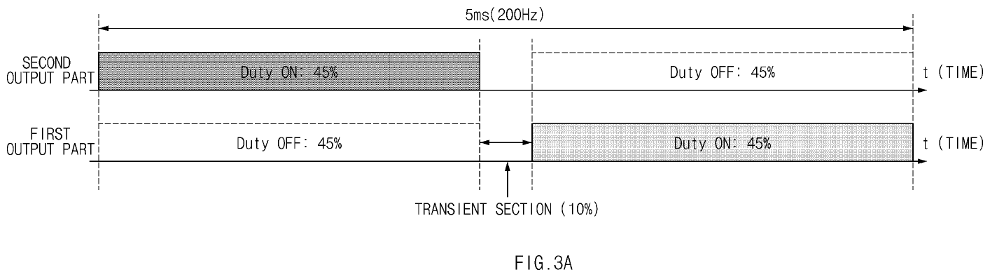

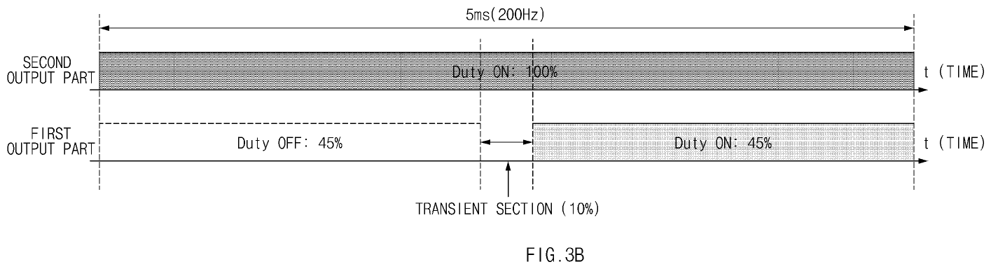

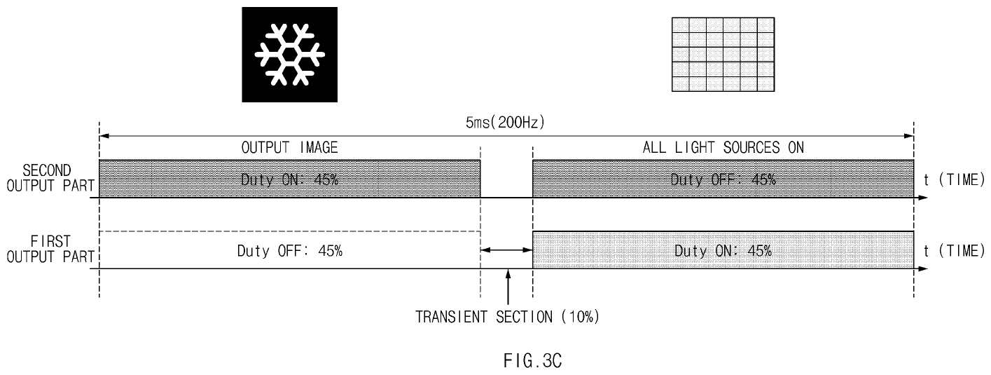

FIGS. 3A to 3C are views illustrating an example of setting duty rates of the first output part and the second output part by the controller according to an embodiment disclosed in the present disclosure.

First, referring to FIG. 3A, the controller 300 may control the lighting of the first output part 100 and the second output part 200 by setting the duty rates of the first output part 100 and the second output part 200.

For example, the controller 300 may control the lighting of the first output part 100 and the second output part 200 by generating a control signal and transmitting the control signal to the first output part 100 and the second output part 200. Then, the control signal may be a digital signal, and for example, may include a PAM signal, a PWM signal, and a PPM signal. For example, the control signal may be a PWM signal, and the duty cycle may include a cycle obtained by expressing operation times (or occupation ratios) of the first output part 100 and the second output part 200 in a period of the PWM signal by a duty rate. For example, the duty rate may include a rate, at which the first output part 100 and the second output part 200 are switched on in a period. Then, the duty rate may be expressed by a rate value of 0 to 1, and may be expressed by a percentage value of 0% to 100%.

According to an embodiment, the controller 300 may control frequencies of the control signals of the first output part 100 and the second output part 200 to a specific value or more. The controller 300 may control the frequencies of the control signals of the first output part 100 and the second output part 200 to a specific value or more to prevent a person from recognizing the repeated lighting of the first output part 100 and the second output part 200 when the person views the lamp 1. For example, the specific value may be set to 60 Hz, by which a person recognizes an image as if the image was continuous.

According to an embodiment, the controller 300 may set the duty rates of the first output part 100 and the second output part 200 such that the on times of the first output part 100 and the second output part 200 do not overlap each other. For example, the controller 300 may perform a control not to simultaneously switch on the first output part 100 and the second output part 200 by setting both of the duty rates of the first output part 100 and the second output part 200 to 50% when a signal period is 10 ms and switching on the first output part 100 for a period of 0 to 5 ms and switching on the second output part 200 for a period of 5 to 10 ms.

According to an embodiment, the controller 300 may set a transient section between the on times of the first output part 100 and the second output part 200. For example, the controller 300 may set the duty rates of the first output part 100 and the second output part 200 to 45% as in FIG. 3, and may set a duty rate of the transient section between the on times of the first output part 100 and the second output part 200 to 10%.

When the controller 300 controls the operations of the first output part 100 and the second output part 200, the first output part 100 and the second output part 200 may be simultaneously switched on due to a timing error, a signal error, and the like in a process of switching on and off the output parts, and to prevent this, the controller 300 may set the duty rate of the transient period between the on times of the output parts.

According to an embodiment, the controller 300 may perform a control such that a sum of the duty rates of the first output part 100 and the second output part 200 and the duty rate of the transient section does not exceed 100%. Through this, the controller 300 may prevent a situation, in which the first output part 100 and the second output part 200 are simultaneously switched on.

Referring to FIG. 3B, the controller 300 may set the duty rate of the second output part 200 to 100%, and may set the duty rate of the first output part 100 to less than 50%. For example, the controller 300 may perform a control such that the first output part 100 is repeatedly switched on and off by setting the duty rate of the first output part 100 to 45% in a state, in which the duty rate of the second output part 200 is 100%. Then, the controller 300 may set the duty rate (for example, 10%) of the transient section between the on/off sections of the first output part 100.

In this way, the controller 300 outputs an image in the second area by continuously switching on the second output part 200, and the visibility of the image may be enhanced in a section, in which the first output part 100 is switched off by repeatedly switching on and off the first output part 100 whereby the visibility of the image may be enhanced as a whole in the entire section.

Referring to FIG. 3C, the controller 300 may perform a control such that the second output part 200 outputs an image when the first output part 100 is switched off, and may switch on all the light sources included in the second output part 200 when the first output part 100 is in an on state.

For example, in FIG. 3C, the controller 300 may set the duty rate of the first output part 100 to 45%, and may switch on all the light sources of the second output part 200 for 45% of one period, in which the first output part 100 is in an on state. In contrast, the controller 300 may perform a control such that the second output part 200 outputs the image when the first output part 100 is in an off state.

In this way, the controller 300 may increase the visibility of the image when the first output part 100 is switched off by repeatedly controlling an output aspect (an image output and all the light sources on) of the second output part 200 as the first output part 100 is switched on and off, and may enhance the field of view of the driver by reinforcing the brightness of the low-beam area when the first output part 100 is switched on. That is, the lamp 1 may enhance the visibility of the image and the visibility of the low-beam area at the same time.

Furthermore, because, among the light sources included in the second output part 200, only the light sources corresponding to the image are switched on when the second output part 200 output the image, the brightness decreases as compared with when all the light sources are switched on (the maximum brightness). Then, the controller 300 may increase an average brightness of the light emitted from the second output part 200 by repeatedly controlling an image output period and a period, in which all the light sources are switched on, of the second output part 200 according to switching-on/off of the first output part 100.

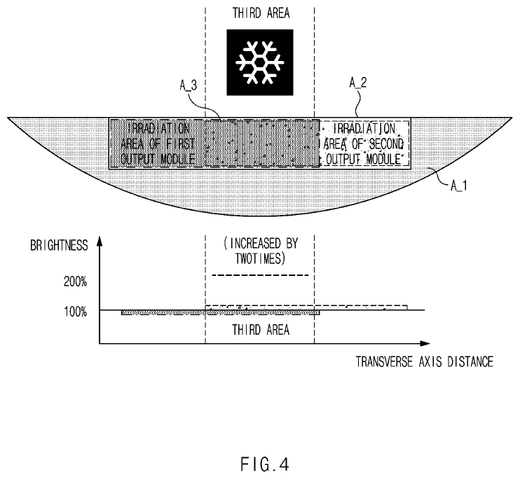

FIG. 4 is a view illustrating an example of outputting an image in the third area by the controller according to an embodiment of the present disclosure.

Referring to FIG. 4, the controller 300 may perform a control to output an image in the third area to output the image brighter.

According to an embodiment, the second output part 200 may include a first output module (not illustrated) and a second output module (not illustrated). The first output module and the second output module may be high-resolution lamp modules that irradiate light, and for example, the first output module may be a left module and the second output module may be a right module.

According to an embodiment, the controller 300 may control the second output part 200 such that an image is displayed in a third area A_3 included in the second area A_2, in which an irradiation area (an area indicated by an alternated long and short dash line) of the first output module and an irradiation area (an area indicated by a dotted line) of the second output module overlap each other. Then, the second area A_2 may be a union of the irradiation area of the first output module and the irradiation area of the second output module.

When the maximum brightnesses, at which the first output module and the second output module may irradiate, are the same (generally, may be set in the same way), the brightness that is two times of the maximum brightnesses because the intensity of the light overlap each other in the third area A_3, in which the irradiation area of the first output module and the irradiation area of the second output area overlap each other. That is, when an image is output in the third area A_3, the image may have a higher brightness than when the image is output in a non-overlapping area, and thus the visibility of the image may be enhanced. Accordingly, the controller 300 may control the second output part 200 such that the image is output in the third area A_3. Furthermore, the controller 300 may also enhance the visibility of the low-beam area by performing a control such that the light source of the first output part 100, which corresponds to an area of the second area A_2, which is not included in the third area A_3, is switched on

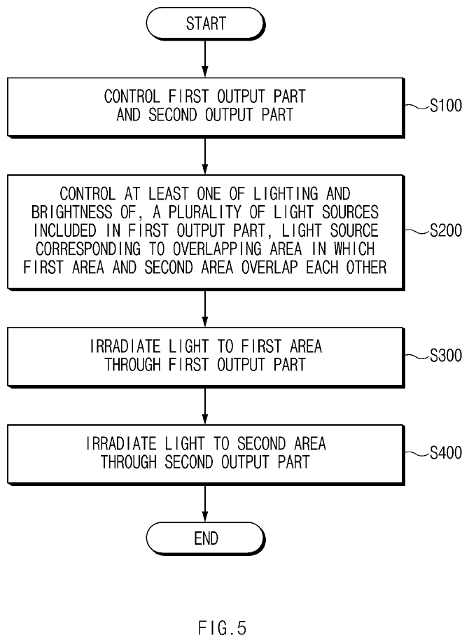

FIG. 5 is a flowchart illustrating a method for operating the lamp according to an embodiment disclosed in the present disclosure.

Referring to FIG. 5, the method for operating the lamp may include operation S100 of controlling the first output part and the second output part, operation S200 of controlling at least one of lighting and a brightness of, among a plurality of light sources included in the first output part, a light source corresponding to an overlapping area, in which a first area and a second area overlap each other, operation S300 of irradiating light to a first area though the first output part, and operation S400 of outputting an image in a second area through the second output part.

In operation S100, the controller 300 may control the first output part 100 and the second output part 200. According to an embodiment, the controller 300 may control the lighting of the first output part 100 and the second output part 200 by setting the duty rates of the first output part 100 and the second output part 200.

In operation S200, the controller 300 may control at least one of lighting and a brightness of, among the plurality of light sources included in the first output part, the light source corresponding to the overlapping area, in which the first area and the second area overlap each other. According to an embodiment, the controller 300 may switch off, among the plurality of light sources included in the first output part 100, the light source corresponding to the overlapping area. According to another embodiment, the controller 300 may decrease the brightness more as, among the plurality of light sources included in the first output part 100, the light source corresponding to the overlapping area corresponds to a point that is closer to the center of the overlapping area.

In operation S300, the first output part 100 may irradiate light to the first area.

In operation S400, the second output part 200 may output the image in the second area.

The lamp according to the embodiments disclosed in the present disclosure may enhance a visibility of an image displayed on a road surface.

Furthermore, the lamp according to the embodiments disclosed in the present disclosure may enhance a visibility of a low-beam area for securing a field of view of a driver.

In addition, various effects that are directly or indirectly recognized though the present disclosure may be provided.

Although it may have been described until now that all the components constituting the embodiments of the present disclosure are coupled to one or coupled to be operated, the present disclosure is not essentially limited to the embodiments. That is, without departing from the purpose of the present disclosure, all the components may be selectively coupled into one or more components to be operated.

Furthermore, because the terms, such as “comprising”, “including”, or “having” may mean that the corresponding component may be included unless there is a specially contradictory description, it should be construed that another component is not extruded but may be further included. In addition, unless defined otherwise, all terms used herein, including technical or scientific terms, have the same meanings as those generally understood by those skilled in the art to which the present disclosure pertains. The terms, such as the terms defined in dictionaries, which are generally used, should be construed to coincide with the context meanings of the related technologies, and are not construed as ideal or excessively formal meanings unless explicitly defined in the present disclosure.

The above description is a simple exemplification of the technical spirits of the present disclosure, and the present disclosure may be variously corrected and modified by those skilled in the art to which the present disclosure pertains without departing from the essential features of the present disclosure. Accordingly, the embodiments disclosed in the present disclosure is not provided to limit the technical spirits the embodiments of the present disclosure but provided to describe the present disclosure, and the scope of the technical spirits of the present disclosure is not limited by the embodiments. Accordingly, the genuine technical scope of the present disclosure should be construed by the attached claims, and all the technical spirits within the equivalent ranges fall within the scope of the present disclosure.

1. A lamp comprising:
a first output part comprising a plurality of light sources configured to irradiate light to a first area;
a second output part configured to output an image in a second area; and
a controller configured to control the first output part and the second output part by setting duty rates of the first output part and the second output part such that light output times of the first output part and the second output part do not overlap each other and by setting a transient section between the light output times of the first output part and the second output part,
wherein the controller is configured to:
control at least one of lighting and a brightness of a light source, among the plurality of light sources included in the first output part, corresponding to an overlapping area in which the first area and the second area overlap each other.

2. The lamp of claim 1, wherein the controller is configured to:
switch off the light source corresponding to the overlapping area.

3. The lamp of claim 1, wherein the controller is configured to:
decrease a brightness of the light source corresponding to the overlapping area as the light source corresponds to a point that is closer to a center of the overlapping area.

4. (canceled)

5. (canceled)

6. (canceled)

7. The lamp of claim 1, wherein the controller is configured to:
set the duty rate of the second output part to 100% and set the duty rate of the first output part to less than 50%.

8. The lamp of claim 1, wherein the controller is configured to:
control the second output part such that the second output part outputs the image when the first output part is in an off state, and
switch on all the light sources included in the second output part when the first output part is in an on state.

9. The lamp of claim 1, wherein the second output part comprises a first output module and a second output module, and wherein the controller is configured to:
control the second output part such that the image is output in a third area included in the second area, in which an irradiation area of the first output module and an irradiation area of the second output module overlap each other.

10. The lamp of claim 1, wherein the first area is a low-beam area and the second area is a high-resolution area.

11. The lamp of claim 1, further comprising:
a storage part configured to store information related to the image.

12. A method for operating a lamp, the method comprising:
controlling a first output part comprising a plurality of light sources that irradiate light to a first area and a second output part configured to output an image in a second area by:
setting duty rates of the first output part and the second output part such that light output times of the first output part and the second output part do not overlap each other; and
setting a transient section between the light output times of the first output part and the second output part;
controlling at least one of lighting and a brightness of a light source, among the plurality of light sources included in the first output part, corresponding to an overlapping area in which the first area and the second area overlap each other;
irradiating the light to the first area through the first output part; and
outputting the image in the second area through the second output part.

13. The method of claim 12, wherein the controlling of at least one of the lighting and the brightness of the light source corresponding to the overlapping area comprises:
switching off the light source corresponding to the overlapping area, among the plurality of light sources included in the first output part.

14. The method of claim 12, wherein the controlling of at least one of the lighting and the brightness of the light source corresponding to the overlapping area comprises:
decreasing the brightness of the light source corresponding to the overlapping area as the light source corresponds to a point that is closer to a center of the overlapping area.

15. (canceled)
